(19) United States
(12) Patent Application Publication
(10) Pub. No.: US 2018/0026323 A1
(43) Pub. Date: Jan. 25, 2018

(54) NON-RECIPROCAL CIRCUIT DEVICE, HIGH-FREQUENCY CIRCUIT, AND COMMUNICATION DEVICE

(71) Applicant: Murata Manufacturing Co., Ltd., Kyoto (JP)

(72) Inventor: Seigo HINO, Kyoto (JP)

(21) Appl. No.: 15/715,512

(22) Filed: Sep. 26, 2017

Related U.S. Application Data
(63) Continuation of application No. PCT/JP2016/054357, filed on Feb. 16, 2016.

(30) Foreign Application Priority Data
Mar. 27, 2015 (JP) 2015-066181

(51) Int. Cl. H01P 1/383; H01P 1/36; H01P 1/30; H01P 1/17

(52) U.S. Cl. CPC H01P 1/383; H01P 1/174; H01P 1/36; H01P 1/30; H01G 4/232

(57) ABSTRACT

A non-reciprocal circuit device includes: a permanent magnet; a ferrite to which a direct current magnetic field is applied by the permanent magnet; and a plurality of center conductors disposed on the ferrite so as to intersect with one another with being insulated from one another. One ends of the respective center conductors serve as input-output ports, and other ends of the respective center conductors are connected to a ground. Capacitance elements are connected in parallel to the respective center conductors. The permanent magnet includes a first permanent magnet and a second permanent magnet. With respect to the first permanent magnet and the second permanent magnet, directions of respective direct current magnetic fields applied to the ferrite are opposite to each other, and there is a difference between temperature characteristics of respective residual magnetic flux densities.

### BACKGROUND OF THE DISCLOSURE

This is a continuation of International Application No. PCT/JP2016/054357 filed on Feb. 16, 2016 which claims priority from Japanese Patent Application No. 2015-066181 filed on Mar. 27, 2015. The contents of these applications are incorporated herein by reference in their entireties.

### Field of the Disclosure

The present disclosure relates to non-reciprocal circuit devices and in particular to a non-reciprocal circuit device, such as an isolator or a circulator, that is used in microwave bands. The present disclosure further relates to a high-frequency circuit and a communication device that include the above-described device.

### Description of the Related Art

Non-reciprocal circuit devices, such as isolators and circulators, have had characteristics such that the non-reciprocal circuit devices transmit signals only in a predetermined specific direction and do not transmit signals in the opposite direction. Through the use of such characteristics, the non-reciprocal circuit devices have been used in transmission circuit portions of mobile communication devices, such as cellular phones.

Patent Document 1 discloses a non-reciprocal circuit device that operates in a magnetic field lower than a magnetic resonance point and that enables both size reduction and low loss. Specifically, FIG. 9 illustrates, as an equivalent circuit, a 3-port type circulator of a lumped constant type. On a ferrite 120 to which a direct current magnetic field is applied by a permanent magnet in a direction indicated by an arrow A, a first center conductor 121 (L1), a second center conductor 122 (L2), and a third center conductor 123 (L3) are disposed so as to intersect with one another at predetermined angles with being insulated from one another. One end of the first center conductor 121 serves as a first port P1 and is connected to a first terminal 141, one end of the second center conductor 122 serves as a second port P2 and is connected to a second terminal 142, and one end of the third center conductor 123 serves as a third port P3 and is connected to a third terminal 143. Furthermore, the other ends of the center conductors 121, 122, and 123 are connected to one another and are also connected to a ground. Capacitance elements C1, C2, and C3 are respectively connected in parallel to the center conductors 121, 122, and 123.

In the 3-port type circulator, a high frequency signal inputted from the second terminal 142 (second port P2) is outputted from the first terminal 141 (first port P1), a high frequency signal inputted from the first terminal 141 (first port P1) is outputted from the third terminal 143 (third port P3), and a high frequency signal inputted from the third terminal 143 (third port P3) is outputted from the second terminal 142 (second port P2).

Operating characteristics are as illustrated in FIG. 10, and FIG. 10 illustrates magnetic permeability μ± with respect to a magnetic field (A/m). The circulator is operated in a low magnetic field region X1 enclosed by a dotted line in FIG. 10. That is, a weak direct current magnetic field is applied to the ferrite so that the circulator operates in a region where the relationship of μ−>μ+>0 is satisfied. Incidentally, the magnetic permeability μ± for a circularly polarized wave is expressed by the following expression (1).

$$\begin{matrix}[ Math . 1 ] & \\ {μ}_{\pm } = 1 + \frac{γ Ms}{{μ}_{0} γ ( Hin + j Δ H / 2 ) \pm ω} & ( 1 )\end{matrix}$$

Now, with a loss term ignored, the relationship of μ+′>0 at a magnetic field strength less than or equal to a magnetic resonance point in FIG. 10 is obtained in the following expression (2) derived from the above expression (1).

[Math. 2]

γ(μ₀Hin+Ms)<ω (2)

γ: gyromagnetic ratio

μ₀: space permeability

Hin: internal magnetic field

Ms: saturation magnetization

ω: angular frequency

Thus, when the internal magnetic field Hin, the saturation magnetization Ms, and so forth are set so that the above expression (2) is satisfied, a lumped constant type non-reciprocal circuit device that operates in a low magnetic field can be provided. Since the lumped constant type non-reciprocal circuit device operates in a low magnetic field, a small-strength magnetic field applied by a permanent magnet will suffice, thereby reducing the size of the permanent magnet, and the size of a magnetic circuit as well.

Incidentally, an operating frequency of a non-reciprocal circuit device is affected by magnetic permeability μ+ for a positive circularly polarized wave, and temperature characteristics of the magnetic permeability μ± therefore have to be stabilized to achieve excellent temperature stability. Although a temperature coefficient of saturation magnetization Ms of ferrite is typically negative, when the strength of a direct current magnetic field applied to the ferrite is constant, the magnetic permeability μ± in low magnetic field operation decreases at a low temperature and increases at a high temperature. Furthermore, when the strength of a direct current magnetic field applied to the ferrite increases, the magnetic permeability μ± in low magnetic field operation decreases. A ferrite magnet is used to apply a direct current magnetic field to the ferrite, and a residual magnetic flux density Br thereof typically has negative temperature characteristics. Thus, in a low temperature range, the strength of a direct current magnetic field applied to the ferrite increases.

Through the above functions, in a low temperature range, an effect of an increase in the saturation magnetization Ms of the ferrite and an effect of an increase in the strength of a direct current magnetic field applied to the ferrite are synergized, and the magnetic permeability μ± decreases. In a high temperature range, an effect of a decrease in the saturation magnetization Ms of the ferrite and an effect of a decrease in the strength of a direct current magnetic field applied to the ferrite are synergized, and the magnetic permeability μ± increases. Thus, the magnetic permeability μ± varies according to temperature, thereby making it impossible to provide a non-reciprocal circuit device that is excellent in temperature stability and operates in a low magnetic field. If there is a ferrite magnet whose temperature characteristics of the residual magnetic flux density Br are greater than or equal to 0, such a drawback can be solved. However, there is no permanent magnet having such temperature characteristics.

FIGS. 11A and 11B illustrate temperature characteristics in the circulator. FIG. 11A illustrates insertion loss from the first port P1 to the third port P3, and FIG. 11B illustrates insertion loss from the third port P3 to the second port P2. Characteristics at a temperature of 25° C. in a normal temperature range, a temperature of −35° C. in a low temperature range, and a temperature of 85° C. in a high temperature range are simulated. It is seen that insertion loss varies both in the low temperature range and in the high temperature range.

Patent Document 1: International Publication No. 2013/168771

### BRIEF SUMMARY OF THE DISCLOSURE

The present disclosure provides a non-reciprocal circuit device that enables both size reduction and low loss and that is also excellent in temperature stability and operates in a low magnetic field, a high-frequency circuit, and a communication device.

A non-reciprocal circuit device according to a first aspect of the present disclosure includes:

a permanent magnet; a ferrite to which a direct current magnetic field is applied by the permanent magnet; and a plurality of center conductors disposed on the ferrite so as to intersect with one another with being insulated from one another.

One ends of the respective center conductors serve as input-output ports, and other ends of the respective center conductors are connected to a ground.

Capacitance elements are connected in parallel to the respective center conductors.

The permanent magnet includes a first permanent magnet and a second permanent magnet.

With respect to the first permanent magnet and the second permanent magnet, directions of respective direct current magnetic fields applied to the ferrite are opposite to each other, and there is a difference between temperature characteristics of respective residual magnetic flux densities.

A high-frequency circuit according to a second aspect of the present disclosure includes: the non-reciprocal circuit device; and a power amplifier.

A communication device according to a third aspect of the present disclosure includes: the non-reciprocal circuit device; and an RFIC.

The non-reciprocal circuit device is of a lumped constant type in which the plurality of center conductors are disposed on the ferrite to which a direct current magnetic field is applied, so as to intersect with one another with being insulated from one another, and functions as a circulator that operates in a low magnetic field, thereby achieving size reduction and low loss. Furthermore, the first permanent magnet and the second permanent magnet that apply direct current magnetic fields to the ferrite are set so that the directions of the respective direct current magnetic fields are opposite to each other and there is a difference between temperature characteristics of the respective residual magnetic flux densities. Thus, in a low temperature range, an effect of an increase in saturation magnetization Ms of the ferrite and an effect of a decrease in the strength of a direct current magnetic field applied to the ferrite compensate each other, thereby reducing a change in magnetic permeability μ± from a normal temperature. In a high temperature range, an effect of a decrease in the saturation magnetization Ms of the ferrite and an effect of an increase in the strength of a direct current magnetic field applied to the ferrite compensate each other, thereby reducing a change in the magnetic permeability μ± from a normal temperature. Thus, excellent temperature stability is achieved.

According to the present disclosure, in the non-reciprocal circuit device that operates in the low magnetic field, both size reduction and low loss can be achieved, and excellent temperature stability can also be obtained.

### BRIEF DESCRIPTION OF THE SEVERAL VIEWS OF THE DRAWINGS

FIG. 1 is an equivalent circuit diagram illustrating a non-reciprocal circuit device (3-port type circulator) according to one embodiment.

FIG. 2 is an exploded perspective view illustrating the circulator illustrated in FIG. 1.

FIG. 3 illustrates an example of a first combination of a ferrite and permanent magnets.

FIGS. 4A and 4B include graphs illustrating temperature characteristics in the circulator illustrated in FIG. 1.

Each of FIGS. 5A and 5B illustrates an example of a second combination of the ferrite and the permanent magnets.

FIG. 6 illustrates an example of a third combination of the ferrite and the permanent magnets.

FIG. 7 illustrates an example of a fourth combination of the ferrite and the permanent magnets.

FIG. 8 is a block diagram illustrating a front-end circuit and a communication device that incorporate the non-reciprocal circuit device (3-port type circulator).

FIG. 9 is an equivalent circuit diagram illustrating a non-reciprocal circuit device (3-port type circulator) in related art.

FIG. 10 is a graph illustrating magnetic permeability for a circularly polarized wave with respect to a magnetic field in a ferrite.

FIGS. 11A and 11B include graphs illustrating temperature characteristics in the circulator illustrated in FIG. 9.

### DETAILED DESCRIPTION OF THE DISCLOSURE

Embodiments of a non-reciprocal circuit device, a high-frequency circuit, and a communication device according to the present disclosure will be described below with reference to the accompanying drawings. In figures, the same members are designated by the same reference numerals, and repeated descriptions thereof are omitted.

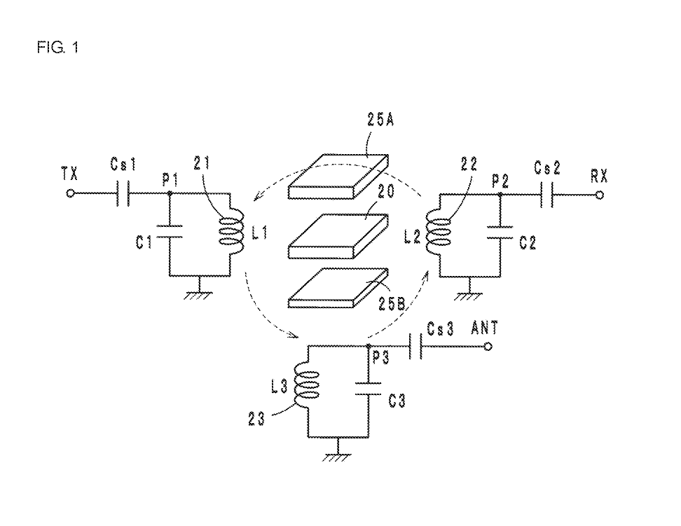

### (One Embodiment of Non-Reciprocal Circuit Device, See FIGS. 1 to 4)

A non-reciprocal circuit device according to one embodiment is a 3-port type circulator of a lumped constant type having an equivalent circuit illustrated in FIG. 1. In other words, on a rectangular microwave ferrite 20 to which direct current magnetic fields are applied by first permanent magnet 25A and second permanent magnet 25B, a first center conductor 21 (L1), a second center conductor 22 (L2), and a third center conductor 23 (L3) are disposed so as to intersect with one another at predetermined angles with being insulated from one another. One ends of the first center conductor 21, the second center conductor 22, and the third center conductor 23 respectively serve as a first port P1, a second port P2, and a third port P3.

Furthermore, the other ends of the center conductors 21, 22, and 23 are connected to a ground. Capacitance elements C1, C2, and C3 are respectively connected in parallel to the center conductors 21, 22, and 23. A capacitance element Cs1 is connected between the first port P1 and a transmission terminal TX. A capacitance element Cs2 is connected between the second port P2 and a reception terminal RX. A capacitance element Cs3 is connected between the third port P3 and an antenna terminal ANT.

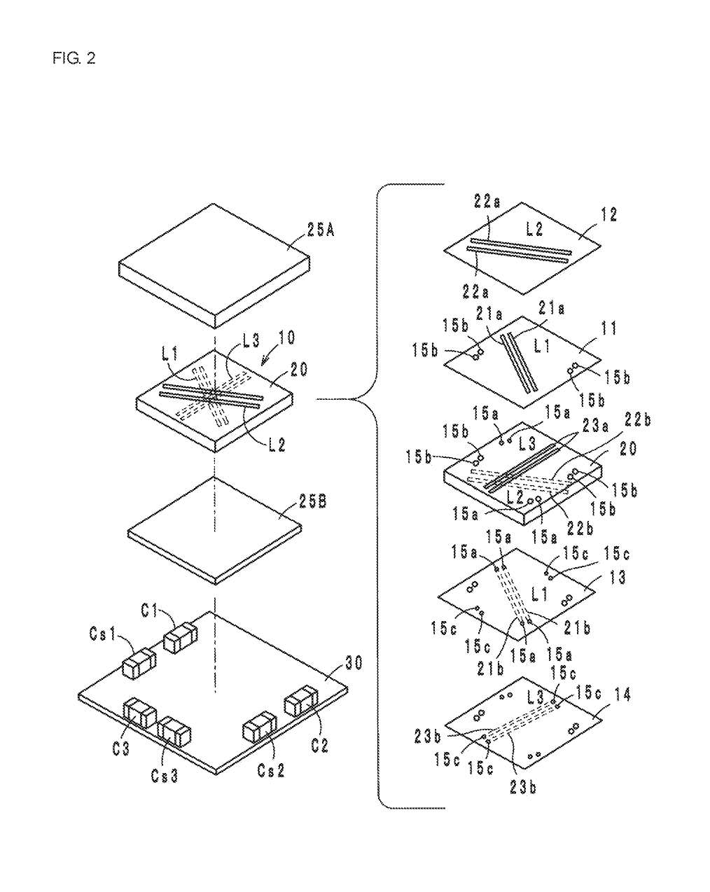

Specifically, the 3-port type circulator composed of the above-described equivalent circuit is constituted by a circuit board 30, a center conductor assembly 10, and the first permanent magnet 25A and the second permanent magnet 25B, as illustrated in FIG. 2.

The center conductor assembly 10 includes insulator layers 11, 12, 13, and 14 stacked on the upper and lower surfaces of the ferrite 20. Conductors 21a forming the first center conductor 21 are formed on the upper surface of the insulator layer 11, conductors 21b are formed on the lower surface of the insulator layer 13, and the conductors 21a are connected to the respective conductors 21b in a coil shape by via hole conductors 15a. Conductors 22a forming the second center conductor 22 are formed on the upper surface of the insulator layer 12, conductors 22b are formed on the lower surface of the ferrite 20, and the conductors 22a are connected to the respective conductors 22b in a coil shape by via hole conductors 15b. Conductors 23a forming the third center conductor 23 are formed on the upper surface of the ferrite 20, conductors 23b are formed on the lower surface of the insulator layer 14, and the conductors 23a are connected to the respective conductors 23b in a coil shape by via hole conductors 15c.

The center conductors 21, 22, and 23 can each be formed on the ferrite 20 as a thin film conductor, a thick film conductor, or conductor foil. In the present embodiment, the center conductors 21, 22, and 23 are each wound two turns around the ferrite 20, but the number of turns is any desired number. For various capacitance elements and inductance elements, chip components are used. For example, the ferrite 20 is 2.0 mm square and 0.15 mm in thickness. The center conductors 21, 22, and 23 each range from 0.06 to 0.2 mm in conductor width. For the insulator layers 11 to 14, photosensitive glass is used. For the center conductors 21, 22, and 23, photosensitive metal paste is used.

On the upper surface of the circuit board 30, electrodes (not illustrated) are formed to mount end portions of the center conductors 21, 22, and 23, and various chip-type capacitance elements and inductance elements. The center conductor assembly 10, the first permanent magnet 25A and the second permanent magnet 25B are stacked and mounted on the circuit board 30, thereby forming the 3-port type circulator composed of the equivalent circuit illustrated in FIG. 1. Conductors formed on the lower surface of the center conductor assembly 10 are connected to electrodes on the circuit board 30 with via hole conductors (not illustrated) formed in the second permanent magnet 25B. Furthermore, on the lower surface of the circuit board 30, the transmission terminal TX, the reception terminal RX, and the antenna terminal ANT, which are not illustrated, are formed.

In the 3-port type circulator, a high frequency signal inputted from the transmission terminal TX (first port P1) is outputted from the antenna terminal ANT (third port P3), and a high frequency signal inputted from the antenna terminal ANT (third port P3) is outputted from the reception terminal RX (second port P2). Although a high frequency signal inputted from the reception terminal RX (second port P2) is outputted from the transmission terminal TX (first port P1) if left uncontrolled, the path thereof is disconnected from circuitry so that no signal is transmitted therethrough.

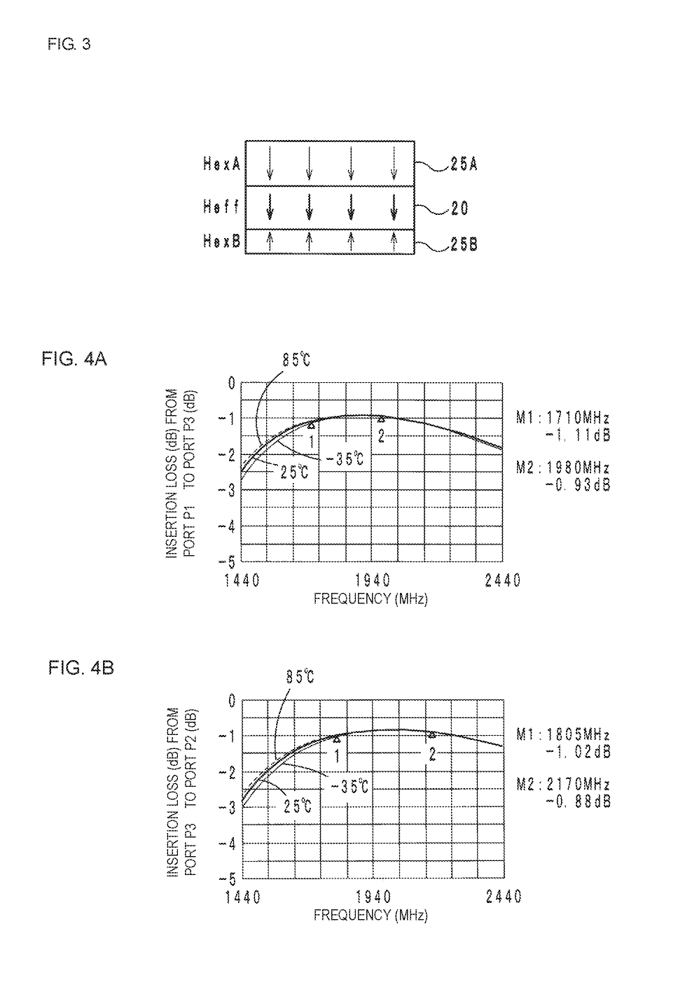

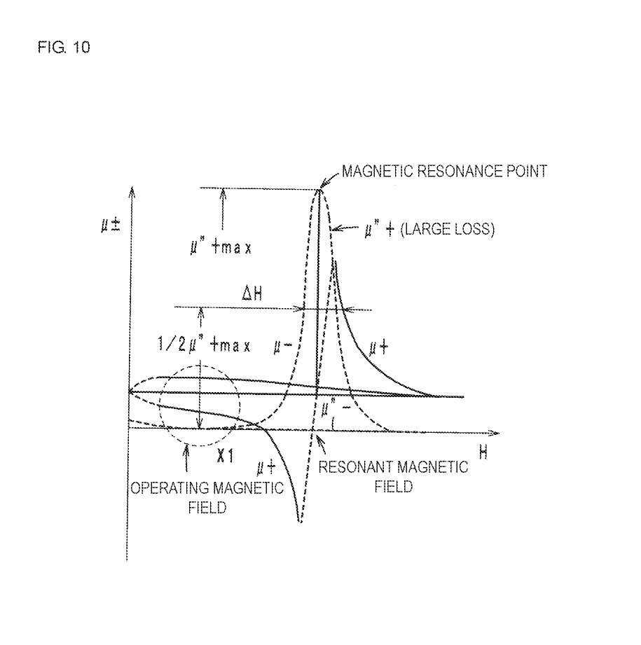

Operating characteristics of the circulator are basically the same as those in the related art illustrated in FIG. 10, and the circulator operates in a magnetic field region X1 lower than a magnetic resonance point. With respect to the first permanent magnet 25A and the second permanent magnet 25B, as illustrated in FIG. 3, the directions of direct current magnetic fields HexA and HexB applied to the ferrite 20 by the respective permanent magnets are opposite to each other, and there is a difference between temperature characteristics of respective residual magnetic flux densities Br. The strength of a direct current magnetic field applied from the first permanent magnet 25A is larger than that of a direct current magnetic field applied from the second permanent magnet 25B, and an effective direct current magnetic field Heff is applied to the ferrite 20. Incidentally, FIG. 3 illustrates an example of a first combination. The first permanent magnet 25A is disposed on the upper surface of the ferrite 20, and the second permanent magnet 25B is disposed on the lower surface of the ferrite 20.

The circulator is of a lumped constant type in which the plurality of center conductors 21, 22, and 23 are disposed on the ferrite 20 so as to intersect with one another with being insulated from one another, and operates in a magnetic field lower than the magnetic resonance point, thereby achieving size reduction and low loss. Furthermore, the first permanent magnet 25A and the second permanent magnet 25B that apply the direct current magnetic field Heff to the ferrite 20 are set so that the directions of the direct current magnetic fields HexA and HexB are opposite to each other and there is a difference between temperature characteristics of the respective residual magnetic flux densities Br. Thus, in a low temperature range, an effect of an increase in saturation magnetization Ms of the ferrite 20 and an effect of a decrease in the strength of the direct current magnetic field Heff applied to the ferrite 20 compensate each other, thereby reducing a change in magnetic permeability μ± from a normal temperature. In a high temperature range, an effect of a decrease in the saturation magnetization Ms of the ferrite 20 and an effect of an increase in the strength of the direct current magnetic field Heff applied to the ferrite 20 compensate each other, thereby reducing a change in the magnetic permeability μ± from a normal temperature. Thus, excellent temperature stability is achieved.

More specifically, the effective direct current magnetic field Heff is represented by the following expression.

Heff=HexA+HexB

Since there is a difference between temperature characteristics of the residual magnetic flux densities Br of the first permanent magnet 25A and the second permanent magnet 25B, temperature characteristics HeffTc of the direct current magnetic field Heff vary according to a combination of temperature characteristics of residual magnetic flux densities of the first permanent magnet 25A and the second permanent magnet 25B. The combination is appropriately set, thereby enabling the temperature characteristics HeffTc to be greater than or equal to 0. When it is assumed that temperature characteristics of the residual magnetic flux density of the first permanent magnet 25A are TcA and temperature characteristics of the residual magnetic flux density of the second permanent magnet 25B are TcB, the following expression is given.

HeffTc=(HexA×TcA+HexB×TcB)/(HexA+HexB)

Calculation examples of the direct current magnetic field Heff are illustrated in the following Table 1 and Table 2. Selection of appropriate temperature characteristics TcA and TcB can provide a magnetic circuit in which temperature characteristics HeffTc of the direct current magnetic field Heff is greater than or equal to 0. As illustrated in Table 1 and Table 2, of a first permanent magnet and a second permanent magnet, when temperature characteristics of one permanent magnet having a larger strength of a direct current magnetic field are larger than temperature characteristics of the other permanent magnet having a smaller strength of a direct current magnetic field, temperature characteristics of a residual magnetic flux density are greater than or equal to 0. Furthermore, as illustrated in Table 1 and Table 2, it is seen that, when a difference between a value of the temperature characteristics of the one permanent magnet having a larger strength of the direct current magnetic field and a value of the temperature characteristics of the other permanent magnet having a smaller strength of the direct current magnetic field is 1000 ppm/° C., HeffTc is exactly 0 ppm/° C. That is, if a difference between a value of the temperature characteristics of the one permanent magnet having a larger strength of the direct current magnetic field is larger and a value of the temperature characteristics of the other permanent magnet having a smaller strength of the direct current magnetic field is greater than or equal to 1000 ppm/° C., a value of HeffTc can reach or exceed 0.

TABLE 1

| Condition | Tc | Hex (A/m) | | |
|---|---|---|---|---|
| (1) | (ppm/° C.) | +25° C. | −35° C. | +85° C. |
| First | −1000 | 4000 | 4240 | 3760 |
| Permanent | | | | |
| Magnet 25A | | | | |
| and Second | | | | |
| Permanent | | | | |
| Magnet 25B | | | | |
| Second | −2000 | −2000 | −2240 | −1760 |
| Permanent | | | | |
| Magnet 25B | | | | |
| Heff | (A/m) | 2000 | 2000 | 2000 |
| HeffTc | (ppm/° C.) | 0 | | |

TABLE 2

| Condition | Tc | Hex (A/m) | | |
|---|---|---|---|---|
| (2) | (ppm/° C.) | +25° C. | −35° C. | +85° C. |
| First | −1000 | 4000 | 4240 | 3760 |
| Permanent | | | | |
| Magnet 25A | | | | |
| Second | −2500 | −2000 | −2300 | −1700 |
| Permanent | | | | |
| Magnet 25B | | | | |
| Heff | (A/m) | 2000 | 1940 | 2060 |
| HeffTc | (ppm/° C.) | 500 | | |

In the case of a combination in Table 1, there are provided HexA: 4000 (A/m), HexB: −2000 (A/m), TcA: −1000 (ppm/° C.), and TcB: −2000 (ppm/° C.), thus giving

HeffTc={4000×(−1000)+(−2000)×(−2000)}/{4000+(−2000)}=0 (ppm/° C.).

In the case of a combination in Table 2, there are provided HexA: 4000 (A/m), HexB: −2000 (A/m), TcA: −1000 (ppm/° C.), and TcB: −2500 (ppm/° C.), thus giving

HeffTc={4000×(−1000)+(−2000)×(−2500)}/4000+(−2000)}=+500 (ppm/° C.).

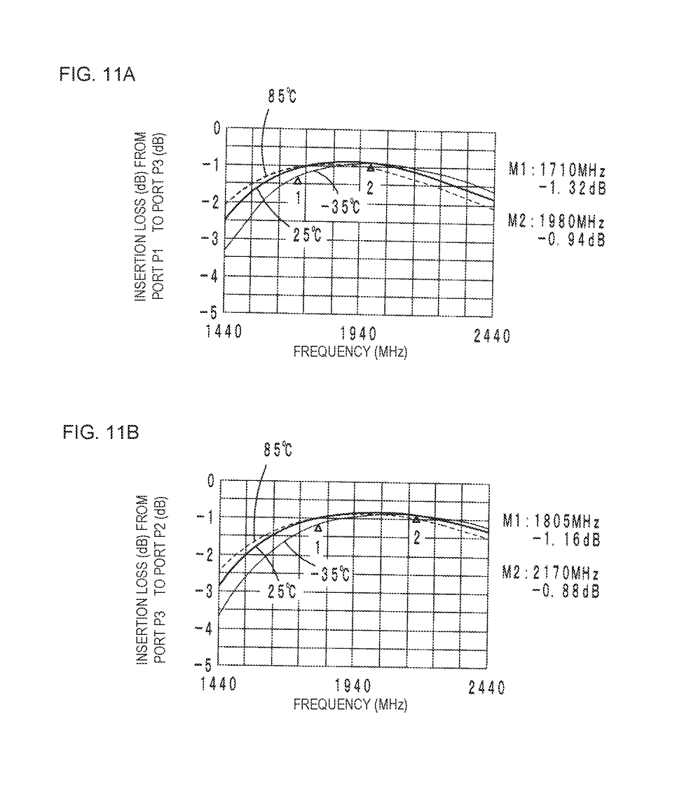

FIGS. 4A and 4B illustrate temperature characteristics in the circulator. FIG. 4A illustrates insertion loss from the port P1 (transmission terminal TX) to the port P3 (antenna terminal ANT), and FIG. 4B illustrates insertion loss from the port P3 (antenna terminal ANT) to the port P2 (reception terminal RX). Characteristics at a temperature of 25° C. in a normal temperature range, a temperature of −35° C. in a low temperature range, and a temperature of 85° C. in a high temperature range are simulated. As is clear from the comparison with the related art illustrated in FIGS. 11A and 11B, variations in characteristics according to temperature are reduced.

Incidentally, as materials of the first permanent magnet 25A and the second permanent magnet 25B, there are materials having temperature characteristics Tc (ppm/° C.) illustrated in the following Table 3. An appropriate combination of these materials enables a reduction in variations in temperature characteristics. For example, a neodymium-based magnet as the first permanent magnet 25A and a ferrite-based magnet as the second permanent magnet 25B are combined. It is desirable that a magnet (neodymium-based, samarium-cobalt-based, or Alnico-based magnet) whose saturation magnetic flux density is large other than a ferrite magnet be used for the first permanent magnet 25A in Table 1 and Table 2, and that a ferrite magnet be used for the second permanent magnet 25B. This is because the first permanent magnet 25A has to generate a direct current magnetic field Hex that is larger than that generated by the second permanent magnet 25B in strength and the use of a magnet whose residual magnetic flux density is large enables a reduction in the size of the magnet (non-reciprocal circuit device).

TABLE 3

| | Tc |
|---|---|
| Permanent Magnet | (ppm/° C.) |
| Ferrite-based Magnet | −2100 to −1700 |
| Neodymium-based Magnet | −1300 to −700 |
| Samarium-cobalt-based Magnet | −600 to −200 |
| Alnico-based Magnet | −400 to −100 |

### (Example of Second Combination, See FIGS. 5A and 5B)

Each of FIGS. 5A and 5B illustrates an example of a second combination of the ferrite 20, the first permanent magnet 25A and the second permanent magnet 25B. In this combination, the first permanent magnet 25A is disposed on one side of the ferrite 20, and the second permanent magnet 25B is disposed on another side of the ferrite 20. The directions of the direct current magnetic fields HexA and HexB applied to the ferrite 20 by the first permanent magnet 25A and the second permanent magnet 25B are opposite to each other. As described above, there is a difference between temperature characteristics of residual magnetic flux densities of both of the permanent magnets. Thus, in the example of the second combination, there are also function effects, as in the example of the first combination. In particular, the first permanent magnet 25A and the second permanent magnet 25B are disposed side by side with the ferrite 20, thereby enabling a reduction in the height of the non-reciprocal circuit device.

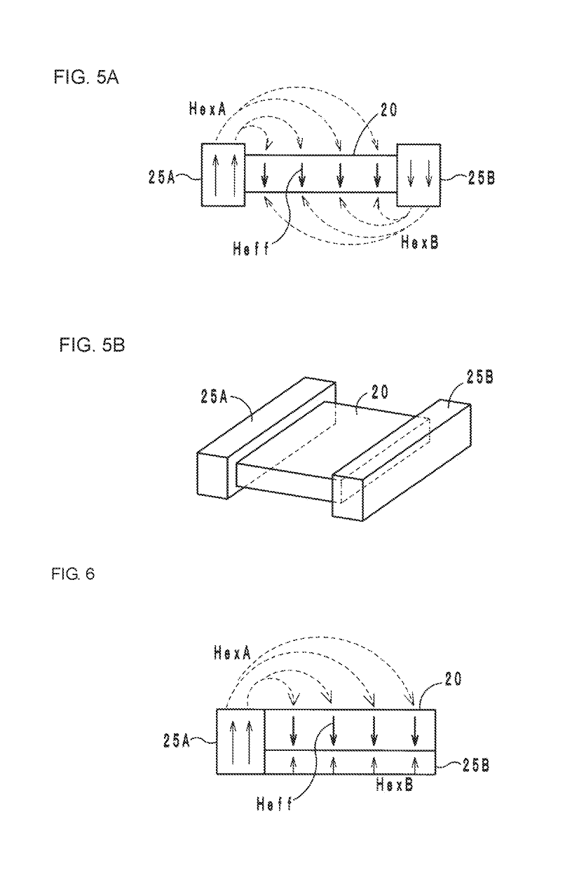

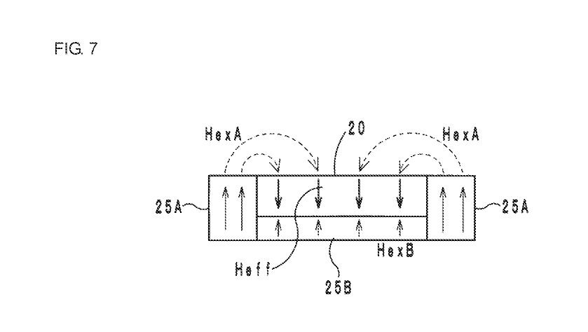

### (Examples of Third and Fourth Combinations, See FIGS. 6 and 7)

With respect to the ferrite 20 and the first permanent magnet 25A and the second permanent magnet 25B, one permanent magnet may be disposed on a side of the ferrite 20, and the other permanent magnet may be disposed on the upper surface or lower surface of the ferrite 20.

FIG. 6 illustrates an example of a third combination. The first permanent magnet 25A is disposed on one side of the ferrite 20, and the second permanent magnet 25B is disposed on the lower surface of the ferrite 20. The directions of the direct current magnetic fields HexA and HexB applied to the ferrite 20 by the first permanent magnet 25A and the second permanent magnet 25B are opposite to each other. As described above, there is a difference between temperature characteristics of residual magnetic flux densities of both of the permanent magnets. Thus, in the example of the third combination, there are also function effects, as in the example of the first combination. In the example of the third combination, magnetic field directions of the first permanent magnet 25A and the second permanent magnet 25B are the same, and thus, after the ferrite 20, the first permanent magnet 25A and the second permanent magnet 25B are assembled, the first permanent magnet 25A and the second permanent magnet 25B can be magnetized or demagnetized at one time. An operating frequency of the non-reciprocal circuit device varies according to the strength of a direct current magnetic field applied to the ferrite 20. In this case, when the first permanent magnet 25A and the second permanent magnet 25B are magnetized or demagnetized simultaneously, the operating frequency is easily adjusted, thereby enabling volume production at low cost. This further enables a reduction in the height of the non-reciprocal circuit device.

FIG. 7 illustrates an example of a fourth combination. The first permanent magnet 25A is disposed on two sides facing each other of the ferrite 20, and the second permanent magnet 25B is disposed on the lower surface of the ferrite 20. The directions of the direct current magnetic fields HexA and HexB applied to the ferrite 20 by the first permanent magnet 25A and the second permanent magnet 25B are opposite to each other. As described above, there is a difference between temperature characteristics of residual magnetic flux densities of both of the permanent magnets. Thus, in the example of the fourth combination, there are also function effects, as in the example of the first combination. In particular, the first permanent magnet 25A are disposed on both sides of the ferrite 20, and the strength of the direct current magnetic field HexA applied to the ferrite 20 thus becomes uniform in comparison with the example of the third combination, thereby improving electrical characteristics.

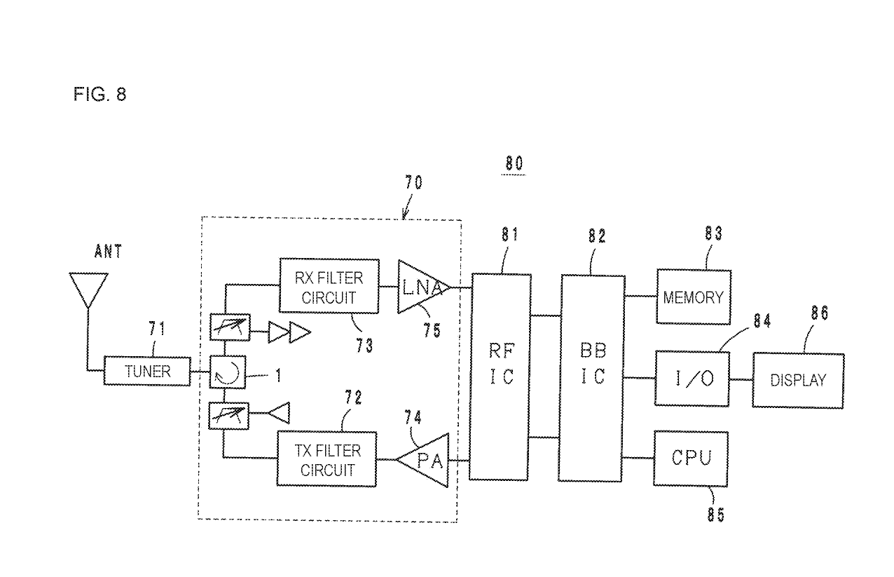

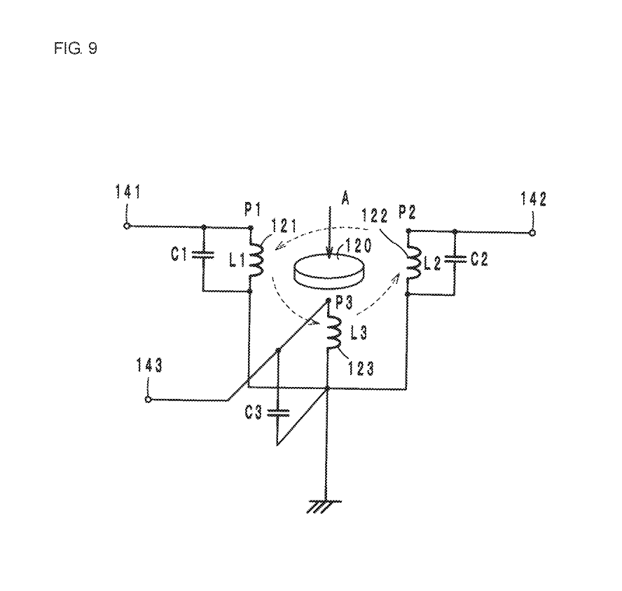

### (Communication Device, See FIG. 8)

Next, a communication device will be described. FIG. 8 illustrates a front-end circuit (high-frequency circuit) 70 including the above-described non-reciprocal circuit device (3-port type circulator denoted by the reference numeral 1), and a communication device (cellular phone) 80 including the circuit 70. The front-end circuit 70 includes the circulator 1 inserted between a tuner 71 of an antenna ANT, a TX filter circuit 72, and an RX filter circuit 73. The filter circuits 72 and 73 are connected to an RFIC 81 via a power amplifier 74 and a low-noise amplifier 75, respectively. In some cases, the front-end circuit 70 can include the antenna ANT and the tuner 71.

The communication device 80 includes the RFIC 81 and a BBIC 82 for the front-end circuit 70. A memory 83, an I/O 84, and a CPU 85 are connected to the BBIC 82. A display 86 and so forth are connected to the I/O 84.

### Other Embodiments

The non-reciprocal circuit device, the high-frequency circuit, and the communication device according to the present disclosure are not intended to be limited to the above-described embodiment, and various modifications can be made thereto within the scope of the gist of the present disclosure.

For example, the configurations, shapes, and so forth of the center conductors may be set as desired. Furthermore, the inductance elements and the capacitance elements are mounted on the circuit board as chip-type elements; alternatively the inductance elements and the capacitance elements may be constituted by conductors embedded in the circuit board.

As described above, the present disclosure is useful in a non-reciprocal circuit device, and, in particular, enables both size reduction and low loss and also achieves excellent temperature stability.

10 center conductor assembly

20 ferrite

21 first center conductor

22 second center conductor

23 third center conductor

25A, 25B first and second permanent magnets

P1, P2, P3 port

C1, C2, C3 capacitance element

70 front-end circuit

80 communication device

1. A non-reciprocal circuit device comprising: a permanent magnet; a ferrite to which a direct current magnetic field is applied by the permanent magnet; and a plurality of center conductors disposed on the ferrite so as to intersect with one another with being insulated from one another,
wherein one ends of the respective center conductors serve as input-output ports, and other ends of the respective center conductors are connected to a ground,
wherein capacitance elements are connected in parallel to the respective center conductors,
wherein the permanent magnet includes a first permanent magnet and a second permanent magnet, and
wherein, directions of respective direct current magnetic fields applied to the ferrite are opposite to each other in the first permanent magnet and the second permanent magnet, and there is a difference between temperature characteristics of respective residual magnetic flux densities in the first permanent magnet and the second permanent magnet.

2. The non-reciprocal circuit device according to claim 1, wherein, of the first permanent magnet and the second permanent magnet, temperature characteristics of a residual magnetic flux density of one permanent magnet having a larger strength of a direct current magnetic field are larger than temperature characteristics of a residual magnetic flux density of another permanent magnet having a smaller strength of a direct current magnetic field.

3. The non-reciprocal circuit device according to claim 1, wherein, there is a difference greater than or equal to 1000 ppm/° C. between temperature characteristics of the residual magnetic flux densities of the first permanent magnet and the second permanent magnet.

4. The non-reciprocal circuit device according to claim 1, wherein the one permanent magnet having a larger strength of a direct current magnetic field is any of a neodymium-based magnet, a samarium-cobalt-based magnet, and an Alnico-based magnet, and the other permanent magnet having a smaller strength of a direct current magnetic field is a ferrite-based magnet.

5. The non-reciprocal circuit device according to claim 1, wherein the first permanent magnet is disposed on an upper surface of the ferrite, and the second permanent magnet is disposed on a lower surface of the ferrite.

6. The non-reciprocal circuit device according to claim 1, wherein the first permanent magnet is disposed on one side of the ferrite, and the second permanent magnet is disposed on another side of the ferrite.

7. The non-reciprocal circuit device according to claim 1, wherein the first permanent magnet is disposed on at least one side of the ferrite, and the second permanent magnet is disposed on an upper surface or lower surface of the ferrite.

8. The non-reciprocal circuit device according to claim 1, wherein an internal magnetic field and saturation magnetization of the ferrite are set so that a following expression is satisfied:
γ(μ₀Hin+Ms)<ω
ω: gyromagnetic ratio
μₒ: space permeability
Hin: internal magnetic field
Ms: saturation magnetization
ω: angular frequency.

9. A high-frequency circuit comprising: the non-reciprocal circuit device according to claim 1; and a power amplifier.

10. A communication device comprising: the non-reciprocal circuit device according to claim 1; and an RFIC.

11. The non-reciprocal circuit device according to claim 2, wherein, there is a difference greater than or equal to 1000 ppm/° C. between temperature characteristics of the residual magnetic flux densities of the first permanent magnet and the second permanent magnet.

12. The non-reciprocal circuit device according to claim 2, wherein the one permanent magnet having a larger strength of a direct current magnetic field is any of a neodymium-based magnet, a samarium-cobalt-based magnet, and an Alnico-based magnet, and the other permanent magnet having a smaller strength of a direct current magnetic field is a ferrite-based magnet.

13. The non-reciprocal circuit device according to claim 3, wherein the one permanent magnet having a larger strength of a direct current magnetic field is any of a neodymium-based magnet, a samarium-cobalt-based magnet, and an Alnico-based magnet, and the other permanent magnet having a smaller strength of a direct current magnetic field is a ferrite-based magnet.

14. The non-reciprocal circuit device according to claim 2, wherein the first permanent magnet is disposed on an upper surface of the ferrite, and the second permanent magnet is disposed on a lower surface of the ferrite.

15. The non-reciprocal circuit device according to claim 3, wherein the first permanent magnet is disposed on an upper surface of the ferrite, and the second permanent magnet is disposed on a lower surface of the ferrite.

16. The non-reciprocal circuit device according to claim 4, wherein the first permanent magnet is disposed on an upper surface of the ferrite, and the second permanent magnet is disposed on a lower surface of the ferrite.

17. The non-reciprocal circuit device according to claim 2, wherein the first permanent magnet is disposed on one side of the ferrite, and the second permanent magnet is disposed on another side of the ferrite.

18. The non-reciprocal circuit device according to claim 3, wherein the first permanent magnet is disposed on one side of the ferrite, and the second permanent magnet is disposed on another side of the ferrite.

19. The non-reciprocal circuit device according to claim 4, wherein the first permanent magnet is disposed on one side of the ferrite, and the second permanent magnet is disposed on another side of the ferrite.

20. The non-reciprocal circuit device according to claim 2, wherein the first permanent magnet is disposed on at least one side of the ferrite, and the second permanent magnet is disposed on an upper surface or lower surface of the ferrite.
